(19) United States
(12) Patent Application Publication
(10) Pub. No.: US 2009/0196676 A1
(43) Pub. Date: Aug. 6, 2009

(54) TIP FOR WRITING INSTRUMENT

(75) Inventors: Hak-Jae KIM, Daejeon (KR); Myeong-Ki KIM, Daejeon (KR)

Correspondence Address: HARRITY & HARRITY, LLP, 11350 Random Hills Road, SUITE 600, FAIRFAX, VA, 22030, US

(73) Assignee: DONG-A PENCIL CO., LTD., Seoul (KR)

(21) Appl. No.: 12/323,801

(22) Filed: Nov. 26, 2008

(30) Foreign Application Priority Data
Jan. 31, 2008 (KR) 20-2008-0001463

(51) Int. Cl. B43K 7/00

(52) U.S. Cl. 401/209

(57) ABSTRACT

The present invention provides a tip for a writing instrument includes: a tip main body; a ball seat formed at the front end of the tip main body, communicated with the ink channel, and having a chamfer on the inner side thereof; a ball retained with a portion exposed, in the ball seat; and an elastic member disposed in the ink channel of the tip main body and always applying force to the ball in the exposure direction, in order to keep the tip clean and achieve a smooth line by preventing ink from remaining at the front end of the tip.

### CROSS-REFERENCE TO RELATED APPLICATION

This application claims priority to and the benefit of Korean Utility Model Application No. 20-2008-0001463 filed in the Korean Intellectual Property Office on Jan. 31, 2008, the entire contents of which are incorporated herein by reference.

### BACKGROUND OF THE INVENTION

The present invention relates to a tip for a writing instrument. More particularly, the present invention relates to a tip for a writing instrument that can keep clean around a ball and a writing line by forming a chamfer to a ball seat to prevent ink remaining at the end from flowing inside when a ball rolls.

In general, a writing instrument, such as a ballpoint pen, is composed of an internal ink storage tube storing ink, a core that is connected to the ink storage tube and has a tip formed at the front end where a ball is rollably disposed with a portion exposed to the outside, and an outer case protecting the core.

The tip of the core is classified into a cone-type tip formed in a cone shape and a needle-type tip formed in a thin tube shape.

The needle-type tip has a tip main body having an ink channel through which ink flows out of an ink storage tube to a ball, and in which an elastic member is disposed in the ink channel of the tip main body to always apply force to the ball in the exposure direction.

A ball seat that is communicated with the ink channel and rollably retains the ball with a portion exposed is formed at the front end of the tip main body.

When rolling over a writing surface, such as a paper surface, the ball is covered with the ink supplied through the ink channel and the exposed portion contacts the writing surface, leaving behind a trail of the ink.

However, according to the ballpoint pen equipped with the needle-type tip in the related art, sometimes the ink coheres to the front end of the tip main body and the cohering ink remains in places on the writing line, thereby making the writing line unsmooth.

Further, un-dried ink cohering on the writing line frequently stains the user's finger or the writing surface, such that a measure is required to solve the problem. The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a tip for a writing instrument that can always keep it clean and achieve a smooth line by forming a chamfer at the front end of a ball seat in order for ink remaining on an exposed portion of a ball to be taken into the ball seat when the ball rolls.

An exemplary embodiment of the present invention provides a tip for a writing instrument including: a tip main body having an internal ink channel; a ball seat formed at the front end of the tip main body and communicated with the ink channel; a ball rollably retained with a portion exposed, in the ball seat; and an elastic member disposed in the ink channel of the tip main body and always applying force to the ball in the exposure direction.

A chamfer is formed at the end of the inner side of the ball seat where the ball is exposed to form a slope such that the diameter of the tip main body increases toward the edge of the front end.

The chamfer has a flat slope or a curved slope.

According to the tip for a writing instrument of the present invention, since the chamfer is formed on the inner side of the ball seat, the ink remaining after writing is smoothly taken into the ball seat until the exposed portion of the ball fully rolls inside the ball seat.

Therefore, since it is possible to prevent the remaining ink from sticking or cohering on or around the front end of the tip main body, the tip is kept clean.

Further, it is possible to minimize the problem in the related art, such as the remaining ink coming off from the tip main body or the ball in writing and being left in places on a writing line or a writing surface, such that it is possible to draw a smooth line.

### BRIEF DESCRIPTION OF THE DRAWINGS

FIG. 1 is a cross-sectional view of an exemplary embodiment of a tip for a writing instrument according to the present invention.

FIG. 2 is an enlarged cross-sectional view of the exemplary embodiment of a tip for a writing instrument according to the present invention.

FIG. 3 is an enlarged cross-sectional view of another exemplary embodiment of a tip for a writing instrument according to the present invention.

FIG. 4 is an enlarged cross-sectional view of further another exemplary embodiment of a tip for a writing instrument according to the present invention.

### DETAILED DESCRIPTION OF THE EMBODIMENTS

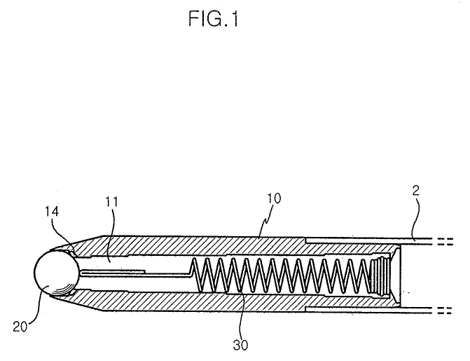

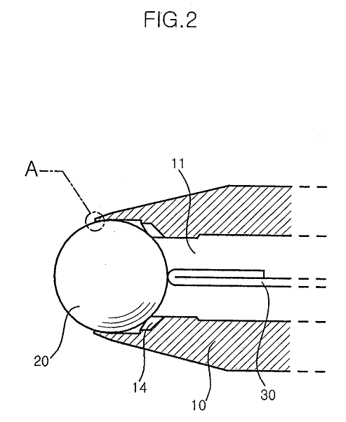

A tip for a writing instrument according to an exemplary embodiment of the present invention, as shown in FIGS. 1 to 3, includes a tip main body 10, a ball seat 14 with a chamfer 16, a ball 20 rollably retained in the ball seat 14, and an elastic member 30 disposed inside the tip main body 10.

The tip main body 10 is formed of a long thin tube having an internal ink channel 11. The rear end of the tip main body 10 is connected to an ink storage tube (not shown).

The ball seat 14 is formed at the front end of the tip main body 10 and connected with the ink channel 11 to be communicated with each other.

The chamfer 16 is formed at the end of an inner side 15 of the ball seat 14 where the ball 20 is exposed.

The chamfer 16 forms a slope such that the diameter of the tip main body 10 increases toward an edge 12 of the front end.

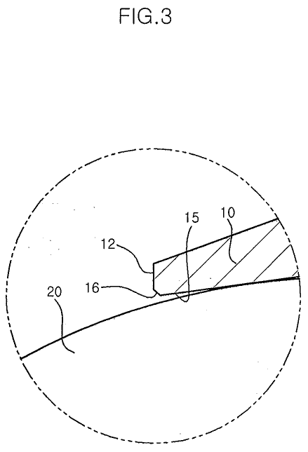

The chamfer 16 has a flat slope, as shown in FIG. 3.

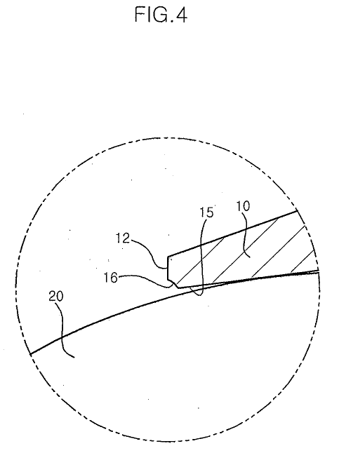

The chamfer 16 may have a curved slope, as shown in FIG. 4.

The ball 20 is rollably retained with a portion exposed, in the ball seat 14.

The elastic member 30 is disposed in the ink channel 12 of the tip main body 10 to always apply force to the ball 20 in the exposure direction.

In the tip for a writing instrument having the above configuration according to an exemplary embodiment of the present invention, when the tip is equipped in a ballpoint pen and rolls over a writing surface, such as a paper surface, the ball 20 is covered with the ink and the exposed portion of the ball 20 contacts the writing surface, leaving a trail of the ink.

That is, as the ball 20 rolls in contact with the writing surface, the exposed portion of the ball 20 leaves ink on the writing surface and rolls inside the ball seat 14, while the portion of the ball 20 inside the ball seat 14 is exposed with ink thereon and leaves the ink on the writing surface. Accordingly, a writing line is left on the writing surface by repeating this process.

In this writing process, ink frequently remains on the exposed portion after the exposed portion of the ball 20 leaves a trail of ink by contacting with the writing surface, and the remaining ink is taken into the ball seat 14 through the chamfer 16 until the exposed portion of the ball 20 fully rolls inside the ball seat 14.

As a result, the remaining ink is prevented from sticking on or around the front end of the tip main body 10, such that the front end can be kept clean and a smooth line can be achieved.

The tip for a writing instrument according to an exemplary embodiment of the present invention can be applied to both of needle-type tip and cone-type tip.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A tip for a writing instrument, comprising:
a tip main body having an internal ink channel;
a ball seat formed at the front end of the tip main body and communicated with the ink channel;
a ball rollably retained with a portion exposed, in the ball seat;
an elastic member disposed in the ink channel of the tip main body and always applying force to the ball in the exposure direction; and
a chamfer formed at the end of the inner side of the ball seat where the ball is exposed to form a slope such that the diameter of the tip main body increases toward the edge of the front end.

2. The tip for a writing instrument of claim 1, wherein the chamfer has a flat slope or a curved slope.
